(19) United States
(12) Patent Application Publication
(10) Pub. No.: US 2013/0337794 A1
(43) Pub. Date: Dec. 19, 2013

(54) BASE STATION, COMMUNICATION SYSTEM AND METHOD OF CONTROLLING BASE STATION, AND COMPUTER READABLE MEDIUM THEREFOR

(71) Applicant: NEC CORPORATION, Tokyo (JP)

(72) Inventor: Masahiko KOJIMA, Tokyo (JP)

(21) Appl. No.: 13/919,368

(22) Filed: Jun. 17, 2013

(30) Foreign Application Priority Data
Jun. 18, 2012 (JP) 2012-136782

(51) Int. Cl. H04W 24/02

(52) U.S. Cl. CPC H04W 24/02
USPC 455/418

(57) ABSTRACT

A base station includes a memory that stores identification information of a cell of the base station and identification information of one or more neighboring cells. The base station also includes a receiver that receives a neighboring cell information message. The received neighboring cell information message includes source-indicating data that indicates a source base station and indicates cell identification information of a respective cell of the source base station; neighboring cell information that includes received identification information of one or more neighbor cells adjacent to the respective cell of the source base station; and sender-indicating data that indicates a sender of the neighboring cell information message. The base station also includes a controller adapted to (1) analyze the received identification information to detect any instance in which the stored identification information of the cell of the base station is present more than one time in the received identification information; and (2) in response to detecting the instance, to carry out an update function of the stored identification information using the received identification information. The sender-indicating data of the received neighboring cell information message indicates a sender other than the source base station.

### CROSS-REFERENCE TO RELATED APPLICATION

This application is based upon and claims the benefit of priority from Japanese patent application No. 2012-136782, filed on Jun. 18, 2012, the disclosure of which is incorporated herein in its entirety by this reference.

### BACKGROUND

Exemplary embodiments of the present invention relate to a base station, a wireless communication system and an identification information change method and program and, more particularly, to a base station, a wireless communication system and an identification information change method and program capable of resolving a conflict between items of cell identification information.

### Description of the Related Art

In a wireless communication system using mobile stations such as portable terminals, a base station performs wireless communication with a mobile station that is located in the cell of its base station.

Cells are each assigned a physical cell ID (PCI) for identification of the cell. PCIs are assigned so that no PCI conflict (no coincidence between PCIs) occurs between the cells adjacent to each other or between the cells that are both adjacent to one of the other cells.

However, the state of adjacency between the cells is changed if the electric wave environment is changed by construction of a high-rise building or installation of a new base station after assignment of the PCIs. If the state of adjacency between the cells is changed, there is a possibility of a PCI conflict between cells that are adjacent to each other or between the cells that are both adjacent to one of the other cells. Occurrence of a PCI conflict causes difficulty in discrimination between the cells adjacent to each other or between the cells that are both adjacent to one of the other cells.

Japanese Patent Laid-Open JP 2012-19468A describes a wireless communication system in accordance with the Long Term Evolution (LTE) standard capable of resolving a PCI conflict.

In this wireless communication system, a base station receives cell information through an X2 interface from each of other two base stations adjacent to it (hereinafter referred to as “neighboring base stations”). The cell information includes a PCI of a cell belonging to the neighboring base station, from which the cell information is transmitted. The X2 interface is an interface between the base stations. A link between the X2 interfaces is referred to as “X2 link” below.

When the base station detects a PCI conflict between cells that respectively belong to the two neighboring base stations by referring to the items of cell information, the base station transmits a PCI change designating request, which indicates the conflicting PCI, to one of the neighboring base stations through the X2 link.

Upon receipt of the PCI change designating request through the X2 link, one of the base stations changes the PCI indicated by the PCI change designating request, i.e., the conflicting PCI.

### SUMMARY

In the wireless communication system, X2 links are not established between all the base stations.

The base station to which the X2 link is not established cannot receive cell information from the neighboring base stations and cannot transmit a PCI change designating request to the neighboring base stations. Therefore the base station to which the X2 link is not established cannot resolve a PCI conflict that occurs between the neighboring base stations. In this case, in order to resolve the PCI conflict, an operator is required to manually change the conflicting PCI.

An object of certain exemplary embodiments is to provide a base station, a wireless communication system and an identification information change method and program capable of resolving the above-described problem.

A base station, which communicates with a controller covering a plurality of base stations, according to certain exemplary embodiments includes: storage means that stores neighboring cell information, which indicates identification information of a cell of the base station and identification information of at least one adjacent cell adjacent to the cell of the base station; transmitting means that transmits the neighboring cell information in said storage means to the controller; and changing means that replaces the identification information of the cell of the base station in said storage means with cell identification information that is different from any identification information indicated in neighboring cell information stored in another of the plurality of base stations when the neighboring cell information stored in the other of the plurality of base stations is received from the controller and if the identification information of the cell of the base station is designated two or more times in the received neighboring cell information.

A base station, which executes handover with respect to a mobile station by using identification information of a cell belonging to the base station, according to certain exemplary embodiments includes: count means that counts the number of times handover ends in failure; and changing means that changes the identification information of the cell belonging to the base station when the count made by said count means is equal to or larger than a predetermined value.

A wireless communication system according to certain exemplary embodiments includes a plurality of base stations and a controller that covers said plurality of base stations, each of said plurality of base stations includes: storage means that stores neighboring cell information, which indicates identification information of a cell of the base station and identification information of at least one adjacent cell adjacent to the cell of the base station; transmitting means that transmits the neighboring cell information in the storage means to the controller; and changing means that replaces the identification information of the cell of the base station in the storage means with cell identification information that is different from any identification information indicated in neighboring cell information stored in another of said plurality of base stations when the neighboring cell information stored in the other of said plurality of base stations is received from the controller and if the identification information of the cell of the base station is designated two or more times in the received neighboring cell information, wherein when said controller receives the neighboring cell information, said controller transmits the neighboring cell information to one of said plurality of base stations different from the base station that has transmitted the neighboring cell information.

An identification information change method according to certain exemplary embodiments carried out by a base station that communicates with a controller that manages a plurality of base stations includes: storing in storage means neighboring cell information, which indicates identification information of a cell of the base station and identification information of at least one adjacent cell adjacent to the cell of the base station; transmitting the neighboring cell information in the storage means to the controller; and replacing the identification information of the cell of the base station in the storage means with cell identification information that is different from any identification information indicated in neighboring cell information stored in another of the plurality of base stations when the neighboring cell information stored in the other of the plurality of base stations is received from the controller and if the identification information of the cell of the base station is designated two or more times in the received neighboring cell information.

An identification information change method according to certain exemplary embodiments carried out by a base station that executes handover with respect to a mobile station by using identification information of a cell belonging to the base station includes: counting the number of times that handover ends in failure; and changing the identification information of the cell belonging to the base station when the count is equal to or larger than a predetermined value.

A program according to certain exemplary embodiments for operating a computer, which communicates with a controller that manages a plurality of base stations, makes the computer execute: a storage process of storing in storage means neighboring cell information, which indicates identification information of a cell of a base station which includes the computer and identification information of at least one adjacent cell adjacent to the cell of the base station; a transmission process of transmitting the neighboring cell information in the storage means to the controller; and a change process of replacing the identification information of the cell of the base station in the storage means with cell identification information that is different from any identification information indicated in neighboring cell information stored in another of the plurality of base stations when the neighboring cell information stored in the other of the plurality of base stations is received from the controller and if the identification information of the cell of the base station is designated two or more times in the received neighboring cell information.

A program according to certain exemplary embodiments for operating a computer, which executes handover with respect to a mobile station by using identification information of a cell that belongs to a base station which includes the computer, makes the computer execute: a count process of counting the number of times that handover ends in failure; and a change process of changing the identification information of the cell that belongs to the base station when the count is equal to or larger than a predetermined value.

Exemplary embodiments ensure that a PCI conflict can be automatically resolved even in a situation where the X2 link is not established.

### BRIEF DESCRIPTION OF THE DRAWINGS

FIG. 1 is a diagram showing wireless communication system 100 in a first exemplary embodiment;

FIG. 2 is a diagram showing an example of base stations 201, 202, and 203;

FIG. 3 is a diagram showing an example of neighboring cell information “cell 201a”;

FIG. 4 is a diagram showing an example of neighboring cell information “cell 202a” in storage section 202b;

FIG. 5 is a diagram showing an example of neighboring cell information “cell 203a” in storage section 203b;

FIG. 6 is a sequence diagram for explaining the operation of wireless communication system 100;

FIG. 7 is a diagram showing wireless communication system 100A in a second exemplary embodiment;

FIG. 8 is a diagram showing an example of base stations 701, 702, and 703;

FIG. 9 is a sequence diagram for explaining the operation of wireless communication system 100A; and

FIG. 10 is a flowchart for explaining the operation of control section 703d in base station 703.

### DETAILED DESCRIPTION

Exemplary embodiments will be described with reference to the drawings. The word “exemplary” is used herein to mean “serving as an example, instance, or illustration”. Any embodiment described herein as “exemplary” is not necessarily to be construed as preferred or advantageous over other embodiments.

### First Exemplary Embodiment

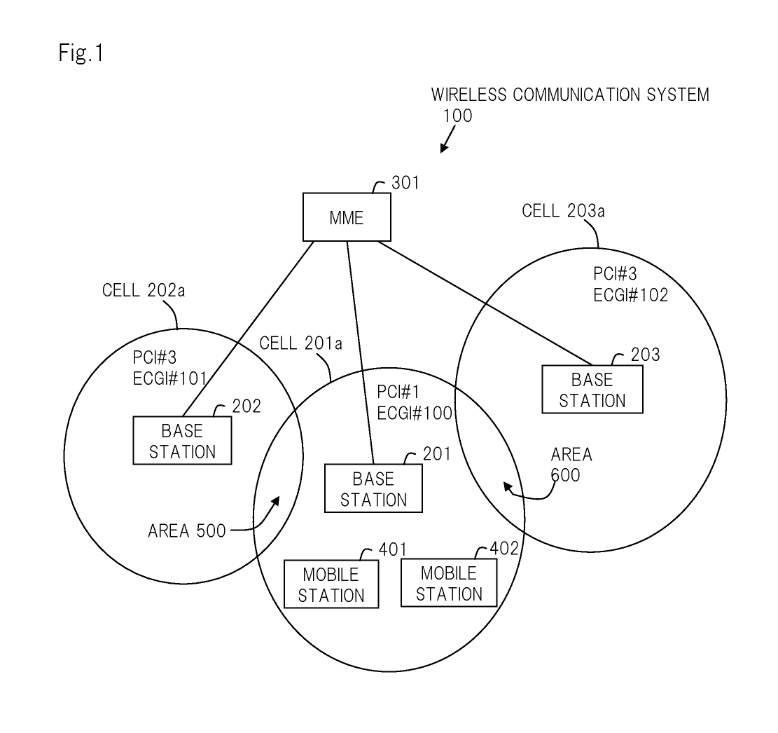

FIG. 1 is a diagram showing a wireless communication system 100 according to a first exemplary embodiment.

Referring to FIG. 1, wireless communication system 100 is, for example, a wireless communication system in accordance with the LTE standard. Wireless communication system 100 includes base stations 201, 202, and 203, mobile management entity (MME or core network node) 301. The number of base stations is not limited to three. Any number of base stations that is no smaller than two may exist.

Each of base stations 201, 202, and 203 has one or more cells.

For ease of description of the present exemplary embodiment, it is assumed that base station 201 has cell 201a; base station 202, cell 202a; and base station 203, cell 203a.

Each of cells 201a, 202a, and 203a is assigned PCI (identification information). In the present exemplary embodiment, PCI#1 is assigned as PCI to cell 201a; PCI#3, to cell 202a; and PCI#3, to cell 203a.

Each of cells 201a, 202a, and 203a is also assigned EUTRAN Cell Global Identity (ECGI) (identification information). In the present exemplary embodiment, ECGI#100 is assigned as ECGI to cell 201a; ECGI#101, to cell 202a; and ECGI#102, to cell 203a.

Each of base stations 201, 202, and 203 performs wireless communication with a mobile station that is located in the cell belonging to itself (for example, base station 201 performs wireless communication with mobile stations 401 and 402).

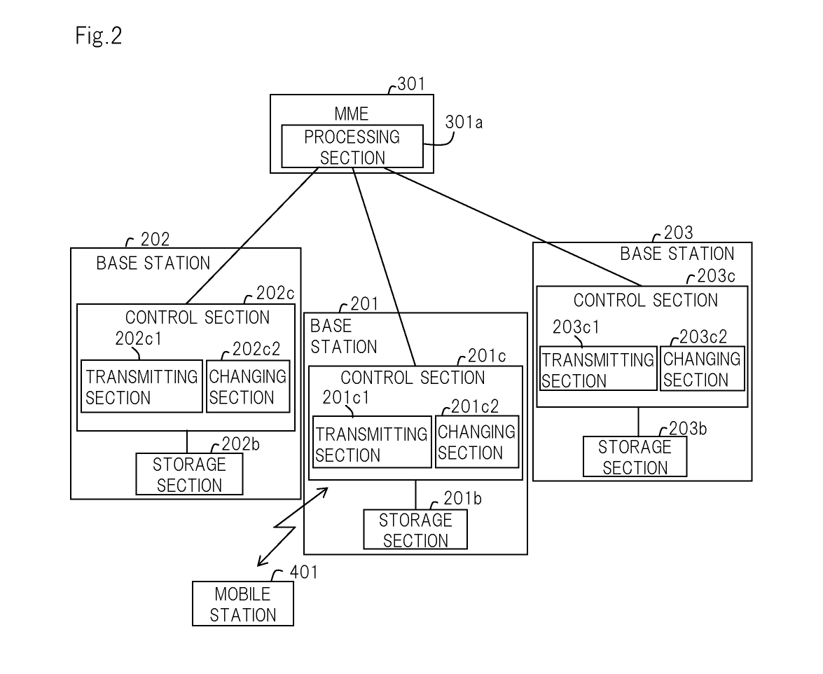

FIG. 2 is a diagram showing an example of base stations 201, 202, and 203.

Referring to FIG. 2, base station 201 includes storage section 201b and control section 201c. Control section 201c includes transmitting section 201c1 and changing section 201c2. Base station 202 includes storage section 202b and control section 202c. Control section 202c includes transmitting section 202c1 and changing section 202c2. Base station 203 includes storage section 203b and control section 203c. Control section 203c includes transmitting section 203c1 and changing section 203c2.

Base station 201 will first be described.

Storage section 201b is an example of storage means. Storage section 201b stores neighboring cell information for handover with respect to cell 201a. Neighboring cell information for handover with respect to cell 201a is referred to as neighboring cell information “cell 201a” below.

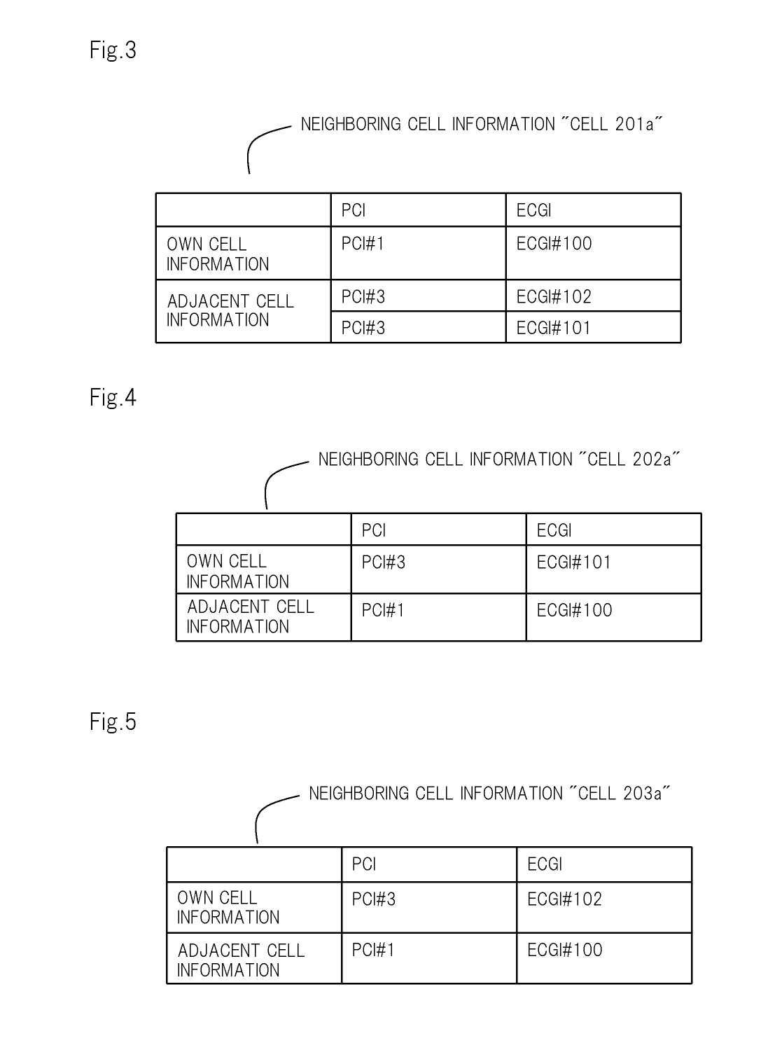

FIG. 3 is a diagram showing an example of neighboring cell information “cell 201a”.

Referring to FIG. 3, neighboring cell information “cell 201a” has a combination of “PCI#1” and “ECGI#100” for identification of cell 201a, a combination of “PCI#3” and

“ECGI#102” for identification of cell 203a adjacent to cell 201a, and a combination of “PCI#3” and “ECGI#101” for identification of cell 202a adjacent to cell 201a.

In the present exemplary embodiment, information in the adjacent cell information in an upper position on the neighboring cell information (the combination of “PCI#3” and “ECGI#102” for identification of adjacent cell 203a in FIG. 3) has a higher priority.

Control section 201c communicates with the mobile station located in cell 201a and also communicates with MME 301 through an S1 interface. No X2 link is established between control section 201a (base station 201) and base station 202 and between control section 201a (base station 201) and base station 203.

Control section 201c controls the operation of base station 201.

Transmitting section 201c1 is an example of transmitting means. Transmitting section 201c1 transmits neighboring cell information “cell 201a” in storage section 201b to MME 301.

For example, transmitting section 201c1 receives a radio resource control (RRC):MEASUREMENT REPORT, which is a handover (HO) trigger message, from mobile station 401.

After receiving RRC:MEASUREMENT REPORT, transmitting section 201c1 identifies the base station as an HO destination based on the PCI contained in RRC:MEASUREMENT REPORT and neighboring cell information “201a” in storage section 201b. A base station identified as an HO destination is referred to as “target base station” below.

After identifying the target base station, transmitting section 201c1 prepares an S1 application protocol (S1AP):HANDOVER REQUIRED including the information for identification of the target base station. S1AP:HANDOVER REQUIRED is an example of a predetermined message for urging MME 301 to transmit S1AP:HANDOVER REQUEST to the other base station. S1AP:HANDOVER REQUEST is an example of a particular message.

After preparing S1AP: HANDOVER REQUIRED, transmitting section 201c1 adds neighbor information (NI), which is neighboring cell information “201a”, to S1AP:HANDOVER REQUIRED.

Transmitting section 201c1 transmits to MME 301 S1AP:HANDOVER REQUIRED to which NI has been added. S1AP:HANDOVER REQUIRED having NI added to it is an example of first information.

Changing section 201c2 is an example of changing means. Changing section 201c2 receives from MME 301 neighboring cell information stored in the other base stations (the base stations other than base station 201). If PCI#1 for the cell of base station 201 is designated two or more times in the received neighboring cell information, changing section 201c2 replaces PCI#1 for the cell of base station 201 in storage section 201b with a PCI (cell identification information) that is different from any of the items of identification information designated in the received neighboring cell information.

For example, when changing section 201c2 receives from MME 301 S1AP:HANDOVER REQUEST including NI that the other base stations have, it determines whether or not there is a conflict between PCI#1 that is assigned to “cell 201a” by referring to the NI that the other base stations have and neighboring cell information “cell 201a” in storage section 201b. S1AP: HANDOVER REQUEST including the NI that the other base stations have received is an example of second information.

In a case where a conflict of PCI#1 that is assigned to the cell (cell 201a) exists, changing section 201c2 replaces PCI#1 that is assigned to the cell (cell 201a) with a value not described in the NI that the other base stations have.

Base stations 202 and 203 will next be described.

Each of storage section 202b in base station 202 and storage section 203b in base station 203 has the same function as that of storage section 201b in base station 201. The description of storage section 202b or 203b may be carried out by replacing “201” in the description of storage section 201b with “202” or “203”.

Each of neighboring cell information “cell 202a” in storage section 202b and neighboring cell information “cell 203a” in storage section 203b differs from neighboring cell information “cell 201a” in storage section 201b.

FIG. 4 is a diagram showing an example of neighboring cell information “cell 202a” in storage section 202b.

Referring to FIG. 4, neighboring cell information “cell 202a” has a combination of “PCI#3” and “ECGI#101” for identification of cell 202a and a combination of “PCI#1” and

“ECGI#100” for identification of adjacent cell 201a.

FIG. 5 is a diagram showing an example of neighboring cell information “cell 203a” in storage section 203b.

Referring to FIG. 5, neighboring cell information “cell 203a” has a combination of “PCI#3” and “ECGI#102” for identification of cell 203a and a combination of “PCI#1” and “ECGI#100” for identification of adjacent cell 201a.

Each of control section 202c and control section 203c has the same functions as those of control section 201c in base station 201. The description of control section 202c or 203c may be carried out by replacing “201” in the description of control section 201c with “202” or “203”.

Each of transmitting section 202c1 and transmitting section 203c1 has the same function as that of transmitting section 201c1 in base station 201. The description of transmitting section 202c1 or 203c1 may be carried out by replacing “201” in the description of transmitting section 201c1 with “202” or “203”.

Each of changing section 202c2 and changing section 203c2 has the same function as that of changing section 201c2 in base station 201. The description of changing section 202c2 or 203c2 may be carried out by replacing “201” in the description of changing section 201c2 with “202” or “203”.

MME 301 is an example of a controller.

MME 301 covers base stations 201, 202, and 203 and communicates with base stations 201, 202, and 203 through S1 interfaces.

MME 301 includes processing section (processing means) 301a.

When processing section 301a receives S1AP:HANDOVER REQUIRED to which NI has been added, for example, it transmits S1AP:HANDOVER REQUEST to which the received NI has been added to the target base station designated by the S1AP:HANDOVER REQUIRED.

Mobile stations 401 and 402 are portable terminals such as portable telephones, smart phones, tablet terminals or portable game machines. Each of mobile stations 401 and 402 communicates with, for example, another mobile station or a server (not shown) that provides a predetermined service through wireless communication system 100. The number of mobile stations is not limited to 2. The number of mobile stations can be changed as required.

The operation will next be described.

The operation of wireless communication system 100 in a situation where mobile station 401 moves out of cell 201a into cell 202a will be described below.

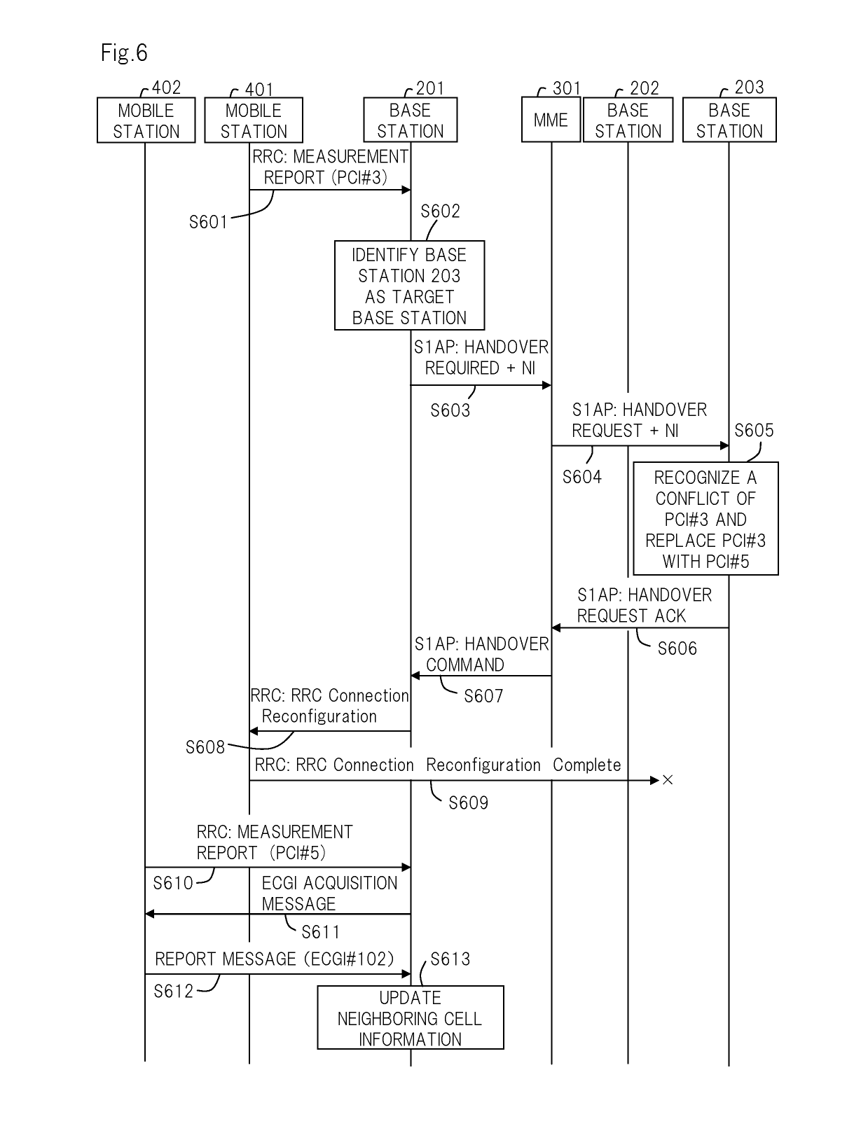

FIG. 6 is a sequence diagram for explaining the operation of wireless communication system 100 in a situation where mobile station 401 moves out of cell 201a into cell 202a.

Mobile station 401 that is present at about the center of cell 201a moves toward cell 202a. When mobile station 401 reaches area 500 (see FIG. 1), which is an overlap between cell 201a and cell 202a, mobile station 401 receives notice information transmitted from base station 202. The notice information transmitted from base station 202 includes PCI#3 and ECGI#101 for cell 202a.

Mobile station 401 receives the notice information transmitted from base station 202 and detects PCI#3 from the notice information.

After detecting PCI#3, mobile station 401 transmits RRC:MEASUREMENT REPORT including PCI#3 to base station 201 (step S601).

In base station 201, transmitting section 201c1 receives RRC:MEASUREMENT REPORT including PCI#3 and reads out PCI#3 from RRC:MEASUREMENT REPORT.

Subsequently, transmitting section 201c1 refers to neighboring cell information “201a” in storage section 201b and identifies the adjacent cell information as having the highest priority (hereinafter referred to as “high-priority cell information”) in the items of adjacent cell information including PCI#3. In the present exemplary embodiment, transmitting section 201c1 identifies as high-priority cell information the adjacent cell information indicating cell 203a identified through the combination of “PCI#3” and “ECGI#102”.

Subsequently, transmitting section 201c1 identifies, as a target base station, base station 203 to which cell 203a that has been identified through the high-priority cell information belongs (step S602).

Subsequently, transmitting section 201c1 prepares S1AP:HANDOVER REQUIRED including the information for identification of the target base station (base station 203) and adds NI, which is neighboring cell information “201a”, to S1AP:HANDOVER REQUIRED.

Subsequently, transmitting section 201c1 transmits S1AP:HANDOVER REQUIRED to which the NI has been added to MME 301 through the S1 interface (step S603).

In MME301, processing section 301a receives S1AP:HANDOVER REQUIRED having the NI added to it and transmits S1AP:HANDOVER REQUEST to which the NI added to S1AP:HANDOVER REQUIRED has been added to the target base station (base station 203) indicated in S1AP:HANDOVER REQUIRED through the S1 interface (step S604).

In base station 203, changing section 203c2 receives S1AP:HANDOVER REQUEST to which the NI has been added and determines whether or not there is a conflict of the PCI#3 that is assigned to “cell 203a” by referring to the NI (see FIG. 3) and neighboring cell information “cell 203a” in storage section 203b (see FIG. 5).

In the present exemplary embodiment, since the received NI signifies that PCI#3 is used for cell 203a having ECGI#102 and for cell 202a having ECGI#101, changing section 203c2 determines that there is a conflict of PCI#3 that is assigned to the cell (cell 203a). After recognizing the conflict of PCI#3 that is assigned to the cell (cell 203a), changing section 203c2 replaces PCI#3 that is assigned to the cell (cell 203a) with a value not described in the received NI (e.g., PCI#5) (step S605).

If there is no conflict of PCI#3 that is assigned to the cell (cell 203a), changing section 203c2 does not change PCI#3 that is assigned to the cell (cell 203a).

Subsequently, changing section 203c2 transmits S1AP:HANDOVER REQUEST ACK to MME 301 (step S606).

In MME 301, processing section 301a receives S1AP:HANDOVER REQUEST ACK and then transmits S1AP:HANDOVER COMMAND to base station 201 (step S607).

In base station 201, transmitting section 201c1 receives S1AP:HANDOVER COMMAND and transmits RRC:RRC Connection Reconfiguration to mobile station 401 (step S608).

Mobile station 401 receives RRC:RRC Connection Reconfiguration and transmits RRC:RRC Connection Reconfiguration Complete in an attempt to achieve synchronization with base station 203. However, since mobile station 401 is not present in cell 203a that belongs to base station 203 but is in area 500, RRC:RRC Connection Reconfiguration Complete does not reach base station 203, and the handover ends in failure (step S609).

Thereafter, when mobile station 402, for example, moves toward cell 203a and reaches area 600 (see FIG. 1), which overlaps between cell 201a and cell 203a, mobile station 402 receives notice information transmitted from base station 203. The notice information transmitted from base station 203 includes new PCI#5 and ECGI#102 for cell 203a.

Mobile station 402 receives the notice information transmitted from base station 203 and detects PCI#5 from the notice information.

After detecting PCI#5, mobile station 402 transmits RRC:MEASUREMENT REPORT including PCI#5 to base station 201 (step S610).

In base station 201, transmitting section 201c1 receives RRC:MEASUREMENT REPORT including PCI#5 and reads out PCI#5 from RRC:MEASUREMENT REPORT.

Subsequently, transmitting section 201c1 refers to neighboring cell information “201a” in storage section 201b and attempts to identify the highest-priority cell information in the items of adjacent cell information including PCI#5.

However, PCI#5 is not in the adjacent cell information. Therefore, transmitting section 201c1 transmits to mobile station 402 a message that transmitting station 201c1 is to obtain the ECGI for the cell to which PCI#5 has been assigned (e.g., RRC:RRC Connection Reconfiguration with the PCI value (PCI#5) designated).

Mobile station 402 receives the message that transmitting station 201c1 is to obtain the ECGI for the cell to which PCI#5 has been assigned, detects ECGI#102 from the notice information, and transmits to base station 201 a message that the ECGI value associated with PCI#5 is ECGI#102 (e.g., RRC:RRC Connection Reconfiguration Complete including ECGI#102 associated with PCI#5) (step S612).

In base station 201, transmitting section 201c1 receives the message that the ECGI value associated with PCI#5 is ECGI#102, and replaces PCI#3, which is associated with ECGI#102 in neighboring cell information “cell 201a” in storage section 201b, with PCI#5 (step S613).

Therefore, when transmitting section 201c1 in base station 201 thereafter receives RRC:MEASUREMENT REPORT including PCI#3 from mobile station 401 that is in area 500, transmitting section 201c1 can identify base station 202 as a target base station since the conflict of PCI#3 has been resolved.

The effects of the present exemplary embodiment will next be described.

In the present exemplary embodiment, storage section 201b stores neighboring cell information “cell 201a” (see FIG. 3). Transmitting section 201c1 transmits neighboring cell information “cell 201a” in storage section 201b to MME 301. Processing section 301a in MME 301 receives neighboring cell information “cell 201a” and transmits neighboring cell information “cell 201a” to a base station different from base station 201 of a plurality of base stations that has transmitted the information (e.g., base station 203). Changing section 203c2 receives from MME 301 neighboring cell information “cell 201a” that is stored in base station 201 and, if PCI#3 that is assigned to the cell is designated two or more times in the received neighboring cell information “cell 201a”, replaces PCI#3 that is assigned to the cell in storage section 203b with PCI that is different from any of the items of identification information designated in the received neighboring cell information “cell 201a”.

Therefore, even in a case where the X2 link as a link between the base stations is not established, neighboring cell information is communicated between the base stations by using the links provided between the base stations and the MME to enable detection of a PCI conflict, thus enabling resolving a PCI conflict.

In the present exemplary embodiment, transmitting section 201c1 transmits to MME 301 S1AP:HANDOVER REQUIRED having NI, i.e., neighboring cell information “cell 201a”, added to it. Changing section 203c2 receives S1AP:HANDOVER REQUEST including NI that the other base stations have and, if PCI#3 that is assigned to the cell (cell 203a) is designated two or more times in the received NI, replaces PCI#3 that is assigned to the cell in storage section 203b with PCI that is different from any of the PCI items designated in the received NI.

Thus, transmission of NI with S1AP:HANDOVER REQUIRED or S1AP:HANDOVER REQUEST is enabled.

In the present exemplary embodiment, S1AP:HANDOVER REQUIRED and S1AP:HANDOVER REQUEST are used as a predetermined message and a particular message. The predetermined message and the particular message can be changed as desired.

For example, S1AP:HANDOVER REQUEST ACKNOWLEDGE and S1AP:HANDOVER COMMAND, S1AP:3NB STATUS TRANSFER and S1AP:MME STATUS TRANSFER or S1AP:ENB CONFIGURATION TRANSFER and S1AP:MME CONFIGURATION TRANSFER may be used as a predetermined message and a particular message.

In a case where S1AP:HANDOVER REQUIRED and S1AP:HANDOVER REQUEST are used as a predetermined message and a particular message, NI is inserted into IE/Group Name: “Source to Target Transparent Container” of the messages, for example.

In a case where S1AP:HANDOVER REQUEST ACKNOWLEDGE and S1AP:HANDOVER REQUEST COMMAND are used as a predetermined message and a particular message, NI is inserted into IE/Group Name: “Target to Source Transparent Container” of the messages, for example.

In a case where S1AP:3NB STATUS TRANSFER and S1AP:MME STATUS TRANSFER are used as a predetermined message and a particular message, NI is inserted into IE/Group Name: “eNB Status Transfer Transparent Container” of the messages, for example.

In a case where S1AP:ENB CONFIGURATION TRANSFER and S1AP:MME CONFIGURATION TRANSFER are used as a predetermined message and a particular message, NI is inserted into IE/Group Name: “SON Configuration Transfer”, for example.

In the present exemplary embodiment, each of transmitting sections 201c1, 202c1, and 203c1 may transmit the neighboring cell information that corresponds to any one of storage sections 201b, 202b, and 203b to MME 301 in a case where the same PCI is designated two or more times in the neighboring cell information in storage section 201b, 202b, or 203b. In such a case, when no PCI conflict exists, that is, the need to transmit the neighboring cell information is low, transmission of the neighboring cell information can be stopped.

### Second Exemplary Embodiment

In the first exemplary embodiment, a base station provides an SiAP message, to which NI has been added, to other base stations through MME 301. In some cases, however, NI cannot be added to an S1AP message and a PCI conflict cannot be noticed.

The second exemplary embodiment includes an example of detection of a PCI conflict that is performed even when NI cannot be added to an SLAP message.

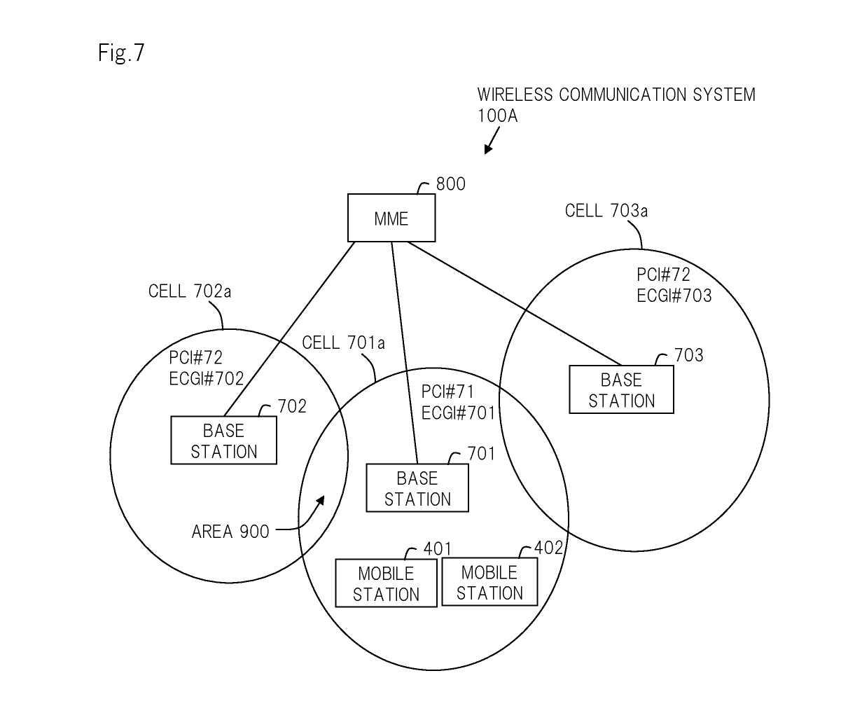

FIG. 7 is a diagram showing wireless communication system 100A in a second exemplary embodiment.

Referring to FIG. 7, wireless communication system 100A is, for example, a wireless communication system in accordance with the LTE standard. Wireless communication system 100A includes base stations 701, 702, and 703, and MME 800. The number of base stations is not limited to three. Any number of base stations that is not smaller than two may exist.

Each of base stations 701, 702, and 703 has one or more cells.

For ease of description of the present exemplary embodiment, it is assumed that base station 701 has cell 701a; base station 702, cell 702a; and base station 703, cell 703a.

Each of cells 701a, 702a, and 703a is assigned PCI. In the present exemplary embodiment, PCI#71 is assigned as PCI to cell 701a; PCI#72, to cell 702a; and PCI#72, to cell 703a.

Each of cells 701a, 702a, and 703a is also assigned ECGI. In the present exemplary embodiment, ECGI#701 is assigned as ECGI to cell 701a; ECGI#702, to cell 702a; and ECGI#703, to cell 703a.

Each of base stations 701, 702, and 703 performs wireless communication with a mobile station positioned in the cell belonging to itself (for example, base station 701 performs wireless communication with mobile stations 401 and 402).

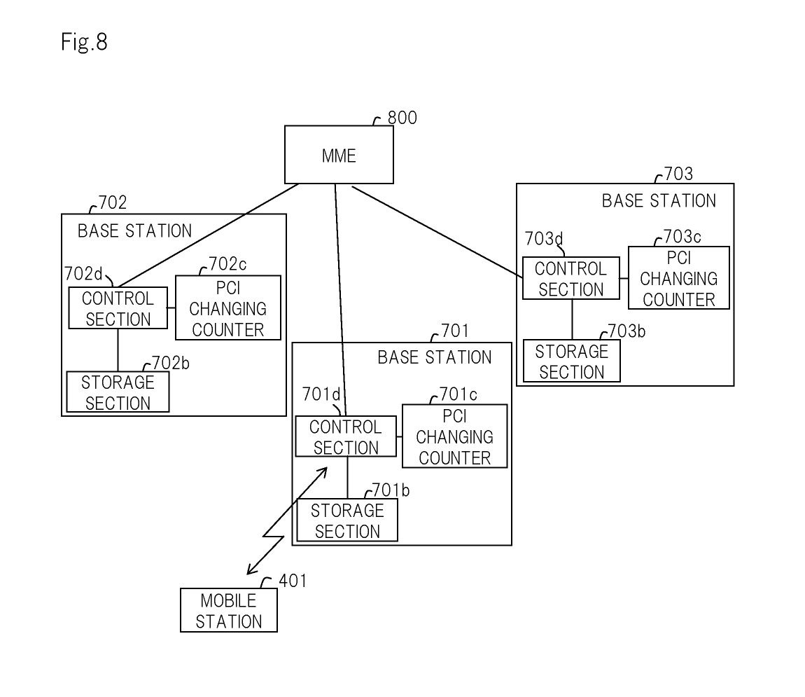

FIG. 8 is a diagram showing an example of base stations 701, 702, and 703. Referring to FIG. 8, base station 701 includes storage section 701b, PCI changing counter 701c and control section 701d. Base station 702 includes storage section 702b, PCI changing counter 702c and control section 702d. Base station 703 includes storage section 703b, PCI changing counter 703c and control section 703d.

Storage sections 701b, 702b, and 703b respectively store neighboring cell information with respect to cell 701a, 702a, and 703a.

Each of PCI changing counters 701c, 702c, and 703c is an example of count means. Each of PCI changing counters 701c, 702c, and 703c counts the number of times that handover ends in failure in the station to which it belongs.

Each of control sections 701d, 702d, and 703d is an example of changing means.

When receiving S1AP:HANDOVER REQUEST from MME 800, each of control sections 701d, 702d, and 703d transmits S1AP:HANDOVER REQUEST ACK to MME 800.

If RRC:RRC Connection Reconfiguration Complete is not received from the mobile station even after a lapse of a predetermined time period from the time at which S1AP:HANDOVER REQUEST ACK is transmitted, each of control section 701d, 702d, and 703d determines that the station to which it belongs failed to perform handover. Time information that indicates the predetermined time period is stored in control sections 701d, 702d, and 703d.

Each of control sections 701d, 702d, and 703d adds 1 to the count made by PCI changing counter 701c, 702c, or 703c in the case of failure to perform handover in the station to which it belongs.

Control sections 701d, 702d, and 703d determine that a PCI conflict exists when the respective counts made by PCI changing counters 701c, 702c, and 703c become equal to or larger than a predetermined value, and change the respective PCIs in storage sections 701b, 702b, and 703c for the cells that belong to the stations to which the control sections belong. The predetermined value is stored in control section 701d, 702d, and 703d.

Each of control sections 701d, 702d, and 703d resets PCI changing counter 701c, 702c, and 703c when a certain time period, after the time at which the count was made by PCI changing counter 701c, 702c, and 703c, is exceeded. Time information indicating the certain time period is stored in control sections 701d, 702d, and 703d. The certain time period is longer than the predetermined time period.

The operation will next be described.

The operation of wireless communication system 100A in a situation where mobile station 401 moves from cell 701a to cell 702a will be described below.

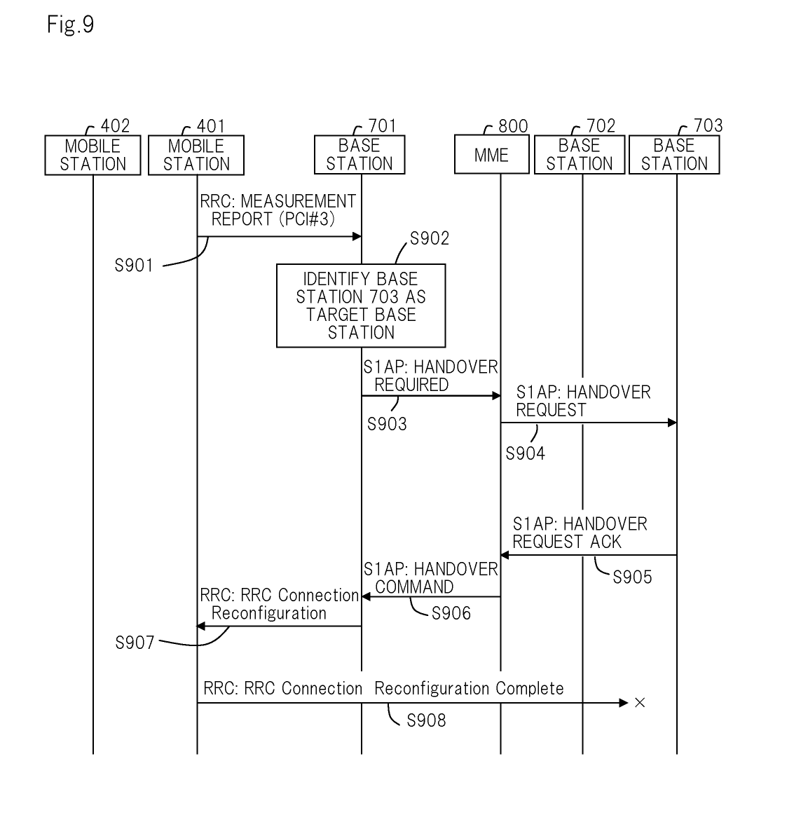

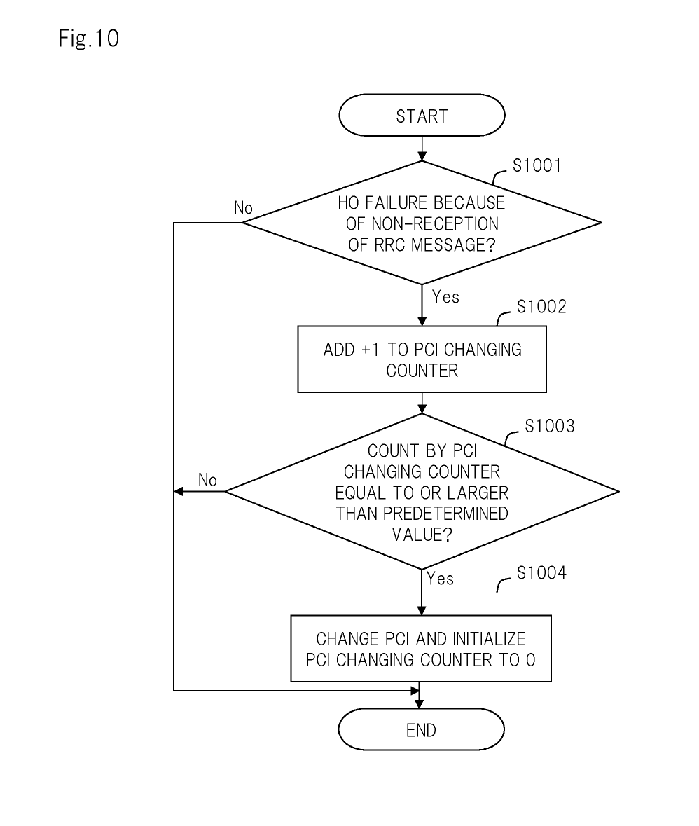

FIG. 9 is a sequence diagram for explaining the operation of wireless communication system 100A in a situation where mobile station 401 moves from cell 701a to cell 702a. FIG. 10 is a flowchart for explaining the operation of control section 703d in base station 703.

Mobile station 401 that is present in cell 701a moves toward cell 702a. When mobile station 401 reaches area 900 (see FIG. 7), which overlaps between cell 701a and cell 702a, mobile station 401 receives notice information transmitted from base station 702. The notice information transmitted from base station 702 includes PCI#72 and ECGI#702 for cell 702a.

Mobile station 401 receives the notice information transmitted from base station 702 and detects PCI#72 from the notice information.

After detecting PCI#72, mobile station 401 transmits RRC:MEASUREMENT REPORT including PCI#72 to base station 701 (step S901).

In base station 701, control section 701d receives RRC:MEASUREMENT REPORT including PCI#72 and reads out PCI#72 from RRC:MEASUREMENT REPORT.

Subsequently, control section 701d refers to neighboring cell information “701a” in storage section 701b and identifies high-priority cell information in the items of adjacent cell information including PCI#72. In the present exemplary embodiment, control section 701d identifies as high-priority cell information the adjacent cell information that indicates cell 703a that was identified through the combination of “PCI#72” and “ECGI#703”.

Subsequently, control section 701d identifies, as a target base station, base station 703 to which cell 703a that was identified through the high-priority cell information belongs (step S902).

Subsequently, control section 701d transmits S1AP:HANDOVER REQUIRED including the information for identification of the target base station (base station 703) to MME 800 through the S1 interface (step S903).

MME 800 receives S1AP:HANDOVER REQUIRED and transmits S1AP:HANDOVER REQUEST to the target base station (base station 703) indicated in S1AP:HANDOVER REQUIRED through the S1 interface (step S904).

In base station 703, control section 703d receives S1AP:HANDOVER REQUEST, then transmits S1AP:HANDOVER REQUEST ACK to MME 800 (step S905) and starts, on a mobile station basis, a timer incorporated in control section 703d.

MME 800 receives S1AP:HANDOVER REQUEST ACK and transmits S1AP:HANDOVER COMMAND to base station 701 (step S906).

In base station 701, control section 701d receives S1AP:HANDOVER COMMAND and transmits RRC:RRC Connection Reconfiguration to mobile station 401 (step S907).

Mobile station 401 receives RRC:RRC Connection Reconfiguration and transmits to base station 703 RRC:RRC Connection Reconfiguration Complete in an attempt to achieve synchronization with base station 703. However, since mobile station 401 is not in cell 703a that belongs to base station 703 but is in area 900, RRC:RRC Connection Reconfiguration Complete does not reach base station 703, and the handover ends in failure (step S908).

In this situation, when the timer corresponding to mobile station 401 indicates the predetermined time period, control section 703d determines that the handover has ended in failure (step S1001), and adds 1 to the count made by PCI changing counter 703c (step S1002).

Subsequently, if the count made by PCI changing counter 703c is equal to or larger than the predetermined value (step S1003), control section 703d determines that a PCI conflict exists, replaces PCI#72 that is assigned to the cell in storage section 703b with a different PCI value, and initializes the count made by PCI changing counter 703c to 0 (step S1004).

The effects of the present exemplary embodiment will next be described.

In the present exemplary embodiment, PCI changing counter 703c counts the number of times handover ends in failure. When the count made by PCI changing counter 703c exceeds the predetermined value, control section 703d changes the PCI that is assigned to the cell that belongs to the station to which control section 703d belongs.

Thus, a PCI conflict can be resolved even in a case where NI cannot be added to an S1AP message.

In each of the exemplary embodiments, each base station may be implemented by means of a computer. In such a case, a computer reads and executes a program recorded on a recording medium such as a compact disk read only memory (CD-ROM) readable with the computer to realize the functions of each base station. The recording medium is not limited to the CD-ROM. The recording medium can be changed as required.

In each of the exemplary embodiments described above, the illustrated configuration is only an example. It should be noted that the present inventive concept is not limited to the above exemplary embodiments but modification can be made as needed without deviating from the spirit and scope as defined by the claims.

What is claimed is:

1. A base station, comprising:
a memory adapted to store identification information of a cell of the base station, and also to store identification information of one or more neighboring cells;
a receiver adapted to receive a neighboring cell information message, the received neighboring cell information message including:
source-indicating data that indicates a source base station and indicates cell identification information of a respective cell of the source base station;
neighboring cell information that includes received identification information of one or more neighbor cells adjacent to the respective cell of the source base station; and
sender-indicating data that indicates a sender of the neighboring cell information message; and
a controller adapted to (1) analyze the received identification information to detect any instance in which the stored identification information of the cell of the base station is present more than one time in the received identification information; and (2) in response to detecting the instance, to carry out an update function of the stored identification information using the received identification information;
wherein the sender-indicating data of the received neighboring cell information message indicates a sender other than the source base station.

2. The base station according to claim 1, wherein the receiver is further adapted to receive the neighboring cell information message according to a S1 Application Protocol (S1AP).

3. The base station according to claim 2, wherein the neighboring cell information message is a S1AP:HANDOVER REQUEST message.

4. The base station according to claim 1, further comprising a counter adapted to count a number of times that a mobile station fails to handover to the base station from the source base station; wherein the controller compares the count of the number of times with a threshold, and carries out the update function after the count reaches the threshold.

5. A communication system, comprising:
a base station;
a source base station; and
a core network node configured to communicate with the base station and source base station,
wherein the base station comprises:
a memory adapted to store identification information of a cell of the base station, and also to store identification information of one or more neighboring cells;
a receiver adapted to receive a neighboring cell information message, the received neighboring cell information message including:
source-indicating data that indicates the source base station and indicates cell identification information of a respective cell of the source base station;
neighboring cell information that includes received identification information of one or more neighbor cells adjacent to the respective cell of the source base station; and
sender-indicating data that indicates a sender of the neighboring cell information message; and
a controller adapted to (1) analyze the received identification information to detect any instance in which the stored identification information of the cell of the base station is present more than one time in the received identification information; and (2) in response to detecting the instance, to carry out an update function of the stored identification information using the received identification information;
wherein the sender-indicating data of the received neighboring cell information message indicates the core network node.

6. A method of controlling a base station, the method comprising:
storing identification information of a cell of the base station, and identification information of one or more neighboring cells;
receiving a neighboring cell information message, the received neighboring cell information message including:
source-indicating data that indicates a source base station and indicates cell identification information of a respective cell of the source base station;
neighboring cell information that includes received identification information of one or more neighbor cells adjacent to the respective cell of the source base station; and
sender-indicating data that indicates a sender of the neighboring cell information message; and
analyzing the received identification information to detect any instance in which the stored identification information of the cell of the base station is present more than one time in the received identification information;
in response to detecting the instance, carrying out an update function of the stored identification information using the received identification information;
wherein the sender-indicating data of the received neighboring cell information message indicates a sender other than the source base station.

7. The method according to claim 6, further comprising:
counting a number of times that a mobile station fails to handover to the base station from the source base station;
comparing the count of the number of times with a threshold; and
carrying out the update function after the count reaches the threshold.

8. A non-transitory computer readable medium including instructions for controlling a processor to implement a method of controlling a base station, the method comprising:
storing identification information of a cell of the base station, and identification information of one or more neighboring cells;
receiving a neighboring cell information message, the received neighboring cell information message including:
source-indicating data that indicates a source base station and indicates cell identification information of a respective cell of the source base station;
neighboring cell information that includes received identification information of one or more neighbor cells adjacent to the respective cell of the source base station; and
sender-indicating data that indicates a sender of the neighboring cell information message; and
analyzing the received identification information to detect any instance in which the stored identification information of the cell of the base station is present more than one time in the received identification information;
in response to detecting the instance, carrying out an update function of the stored identification information using the received identification information;
wherein the sender-indicating data of the received neighboring cell information message indicates a sender other than the source base station.

9. The non-transitory computer readable medium according to claim 8, wherein the method further comprises:
counting a number of times that a mobile station fails to handover to the base station from the source base station;
comparing the count of the number of times with a threshold; and
carrying out the update function after the count reaches the threshold.
